(19) United States
(12) Patent Application Publication
(10) Pub. No.: US 2018/0049447 A1
(43) Pub. Date: Feb. 22, 2018

(54) FRESHNESS PRESERVATION METHOD

(71) Applicant: W & Co., Tokyo (JP)

(72) Inventor: Toru WATANABE, Tokyo (JP)

(73) Assignee: W & Co.

(21) Appl. No.: 15/358,141

(22) Filed: Nov. 22, 2016

(30) Foreign Application Priority Data
Aug. 19, 2016 (JP) 2016-160949

(51) Int. Cl. A23B 7/005; B65D 81/26; B65D 33/20; B65D 65/40

(52) U.S. Cl. CPC A23B 7/0056; B65D 81/263; A23V 2002/00; B65D 65/40; B65D 33/20

(57) ABSTRACT

The present invention provides a freshness preservation method and a freshness preservation bag that enables to keep freshness of a vegetable, fruit or fresh flower for a long period. A storage bag 10 is formed by a nonporous film 1. Non-adhesive portions are continuously formed on a heat sealed portion 11 of the storage bag 10. The non-adhesive portions function as the vent holes 2 communicating with the outside of the storage bag 10. The carbon dioxide generated from the vegetable, fruit or fresh flower in the storage bag 10 is discharged from the vent holes 2. The oxygen of the outside is shut off by the vent holes 2. The vegetable, fruit or fresh flower is allowed to breath only by the oxygen sealed in the storage bag 10. An oxygen concentration is gradually reduced according to a degree of breathing of each of the vegetable, fruit or fresh flower.

### CROSS-REFERENCES TO RELATED APPLICATIONS

This patent specification is based on Japanese patent application, No. 2016-160949 filed on Aug. 19, 2016 in the Japan Patent Office, the entire contents of which are incorporated by reference herein.

### BACKGROUND OF THE INVENTION

### 1. Field of the Invention

The present invention relates to a freshness preservation method and a freshness preservation bag that enable to preserve freshness of vegetable, fruit or fresh flower for a long period by adjusting an amount of carbon dioxide and oxygen according to breathing of the stored vegetable, fruit or fresh flower.

### 2. Description of the Related Art

As exemplified by MAP (Modified Atmosphere Packing), a packing method of sealing and packaging the vegetable, fruit or fresh flower by a film having gas permeability and gas adsorptive property to adjust a gas composition such as carbon dioxide and oxygen in a package is known for preserving freshness of the vegetable, fruit or fresh flower. However, in many fruits, vegetables or flesh flowers, there is a risk of physiological disorder because of too much carbon dioxide stored in the package or too little oxygen in the package. Accordingly, an open package (perforated package) and a package made of nonporous film on which fine openings are partly formed are selected in many cases.

For example, Patent document 1 discloses a package formed by heat-sealing a nonporous film. In the package of Patent document 1, a passage having an opening area of 10 to 400 mm² and a passage length of 5 to 15 mm is formed on the heat sealed portion formed by the nonporous film so that water vapor generated from the vegetable, fruit or fresh flower is concentrated on the passage and the package is sealed by the blocking action of the water vapor. Thus, external air under the atmospheric pressure does not enter the package, and the internal air passes through outside when the internal pressure becomes higher than the atmospheric pressure according to breathing of the vegetable, fruit or fresh flower.

However, in the package of Patent document 1, the air flows only one way from the inside of the package to the outside. Accordingly, Patent document 2 states, in an invention of a freshness preservation method, that fresh oxygen is not taken in the package of Patent document 1 almost at all, and bad odor and decay occur because of gas injury.

In the freshness preservation method described in Patent document 2, the state of low oxygen concentration and high carbon dioxide concentration is required to preserve freshness. However, although the low oxygen concentration is required, lack of oxygen is caused when the oxygen concentration is lower than 1%. In the freshness preservation method of Patent document 2, the vegetable, fruit or fresh flower stored in a bag breathes through fine gaps of the non-adhered portion of the bag which is formed by heat-sealing the nonporous film. Thus, the vegetable, fruit or fresh flower is kept in the state of low oxygen concentration and high carbon dioxide concentration in a range of avoiding an anaerobic condition.

Namely, the freshness preservation method of Patent document 2 enables the ventilation from the inside to the outside and from the outside to the inside (i.e., bidirectional ventilation). Consequently, the ventilation from inside of the bag to the outside and the ventilation from the outside of the bag to the inside are simultaneously done through the breathing of the vegetable, fruit or fresh flower stored in the bag. Thus, the state of low oxygen concentration and high carbon dioxide concentration is easily and naturally kept in the bag in a range of avoiding an anaerobic condition, and freshness of the vegetable, fruit or fresh flower is preserved for a long period.

On the other hand, Patent document 3 proposed by the applicant of the present invention discloses a food degassing bag capable of degassing carbon dioxide gas generated from food in a packaged state. The food degassing bag of Patent document 3 is invented for eliminating the risk of burst of the bag, for example, when coffee beans are packed in the bag and the bag is filled with carbon dioxide gas generated from the coffee beans. To solve the problem, in the food degassing bag of Patent document 3, a degassing layer composed of a polyethylene layer and an oxygen barrier layer is formed on an inner side of a packaging film. In addition, non-adhesive portions are sequentially formed on an adhesive layer that adheres the packaging film layer and the oxygen barrier layer of the degassing layer showing a stripe pattern, and the non-adhesive portions form degassing vents leading to the outside of the storage bag. Consequently, a stable gas venting operation can be obtained in response to carbon dioxide gas produced in different amounts.

[Patent document 1] Japanese Unexamined Patent Application Publication No. S57-125165

[Patent document 2] Japanese Patent No. 3259166

[Patent document 3] Japanese Patent No. 5770356

### BRIEF SUMMARY OF THE INVENTION

In the package described in Patent document 1, the water vapor generated from the vegetable, fruit or fresh flower is concentrated on the passage to block the passage, and the passage blocked by the water vapor is opened by the internal pressure when the internal pressure becomes higher than the atmospheric pressure according to breathing of the vegetable, fruit or fresh flower so that the internal air passes through the outside. Accordingly, when storing the vegetable, fruit or fresh flower that generates water vapor little or when storing it in an environment in which the water vapor is easily dried, an amount of water concentrated on the passage is small. In such situation, there is a disadvantage that unexpected result is easily caused.

In the freshness preservation method described in Patent document 2, the ventilation from the inside to the outside and from the outside to the inside (i.e., bidirectional ventilation) is enabled. Thus, the state of low oxygen concentration and high carbon dioxide concentration is kept in a range of avoiding an anaerobic condition. Accordingly, freshness of the vegetable, fruit or fresh flower can be preserved for a long period. However, when storing the vegetable, fruit or fresh flower in the package, air is simultaneously enclosed in the package. It requires a time to discharge the enclosed oxygen until the environment becomes the low oxygen concentration. Thus, it requires a long time before the storage condition of low oxygen concentration and high carbon dioxide concentration is satisfied. Accordingly, the vegetable, fruit or fresh flower may be taken out from the package before forming freshness preserving environment.

On the other hand, the inventor of the present invention found unexpected freshness preserving effect when vegetables are stored by using the food degassing bag described in Patent document 3. The food degassing bag of Patent document 3 was originally configured for obtaining degassing effect of the carbon dioxide gas even when the internal pressure in the storage bag was low. Thus, there was no purpose for preserving freshness of the vegetable, fruit or fresh flower.

However, the inventor was convinced that some configurations or actions of the food degassing bag were extremely effective for preserving freshness of the vegetable, fruit or fresh flower. In the present invention, from the viewpoint of preserving freshness, the configuration of the food degassing bag was newly studied to provide a freshness preservation method and a freshness preservation bag capable of maintaining freshness of the vegetable, fruit or fresh flower for a long period.

The first aspect of the present invention is a freshness preservation method, comprising the step of entering a vegetable, fruit or fresh flower in a storage bag 10 that is formed by heat-sealing a nonporous film 1 to continuously form non-adhesive portions on a heat sealed portion 11 in a stripe pattern so that the non-adhesive portions function as vent holes 2 communicating with an outside of the storage bag 10, wherein carbon dioxide generated by the vegetable, fruit or fresh flower in the storage bag 10 is discharged from the vent holes 2, and oxygen of the outside of the storage bag 10 is shut off by the vent holes 2 to allow the vegetable, fruit or fresh flower breath only by the oxygen entered in the storage bag 10 so that an oxygen concentration in the storage bag 10 is gradually reduced according to a degree of breathing of the vegetable, fruit or fresh flower.

In the second aspect, a width W of the vent holes 2 is 0.2 mm to 5 mm, and a ratio L/W between the width W and a length L of the vent holes 2 is 10 to 200. Here, the length L is a distance from an inside of the storage bag 10 to the outside of the storage bag 10.

The third aspect is a freshness preservation bag using the freshness preservation methods described above, wherein the vent holes 2 are formed on the heat sealed portion 11 of the storage bag 10 which is formed by heat-sealing the nonporous film 1.

In the freshness preservation bag of the fourth aspect, the nonporous film 1 has a single layer structure made of one of polyethylene, polypropylene, polyester and nylon, or a laminated structure of a combination of at least two of the polyethylene, the polypropylene, the polyester and the nylon.

In the freshness preservation bag of the fifth aspect, the nonporous film 1 has a structure formed by laminating an oxygen barrier layer, and the oxygen barrier layer is formed by a layer made of a polymer including vinyl alcohol or vinylidene chloride, a layer formed by vapor-depositing one of silica, alumina and aluminium, or a layer of metallic foil.

In the freshness preservation bag of the sixth aspect, 5 to 200 vent holes are formed on the heat sealed portion 11.

By using the freshness preservation method of the present invention, an oxygen concentration in the storage bag is gradually reduced according to a degree of breathing of the vegetable, fruit or fresh flower. Thus, the freshness can be preserved in accordance with each of the vegetable, fruit or fresh flower and freshness preserving period can be extended successfully.

By using the freshness preservation bag of the present invention, freshness preservation effect can be easily obtained only by storing food, vegetable, fruit or fresh flower in the storage bag.

The reason why freshness is maintained by using the present invention is guessed as follows. The carbon dioxide generated from the vegetable, fruit or fresh flower in the storage bag is discharged from the vent holes, and the oxygen outside of the storage bag is shut off by the carbon dioxide filled in the vent holes. Thus, the oxygen is consumed by the breathing of the vegetable, fruit or fresh flower in the storage bag. Consequently, the oxygen concentration is reduced and the carbon dioxide concentration is increased.

The oxygen concentration is reduced according to a degree of the breathing of the vegetable, fruit or fresh flower itself although the degree varies depending on the vegetable, fruit or fresh flower. Accordingly, it is guessed that the vegetable, fruit or fresh flower gradually and temporarily stops its activity with less damage. When the fresh flower preserved for a long period by using the present invention was taken out of the storage bag and put into water again, a phenomenon that the flower started to suck up the water was confirmed. Also from the above described phenomenon, validity of the guess seems to be high.

When the width W of the vent holes is 0.2 mm to 5 mm and the ratio between the length L and the width W is 10 or more, the carbon dioxide is unilaterally discharged from the vent holes since the gas pressure is increased according to the breathing of the vegetable, fruit or fresh flower. Thus, the oxygen is prevented from flowing in the vent holes.

### BRIEF DESCRIPTION OF THE DRAWINGS

FIG. 1 is a rear view showing an embodiment of a bag body of the present invention.

FIG. 2 is a rear view showing another embodiment of a bag body of the present invention.

FIG. 3 is a sectional view of a main part showing a state that vent holes are formed on a heat sealed portion of the present invention.

FIG. 4 is a sectional view of a main part showing an embodiment of the vent holes of the present invention.

FIG. 5 is a sectional view of a main part showing another embodiment of the vent holes of the present invention.

FIG. 6 is a plan view showing an embodiment of the vent holes of the present invention.

FIGS. 7A to 7C are plan views showing another embodiment of the vent holes of the present invention.

### DETAILED DESCRIPTION OF THE INVENTION

The target to preserve the freshness in the present invention is plants, such as vegetables, fruits and fresh flowers. These plants generate carbon dioxide and water vapor during storage by their own breathing. In addition, these plants are deteriorated by oxygen. The “vegetable, fruit or fresh flower” in the present invention includes these plants such as vegetables, fruits and fresh flowers.

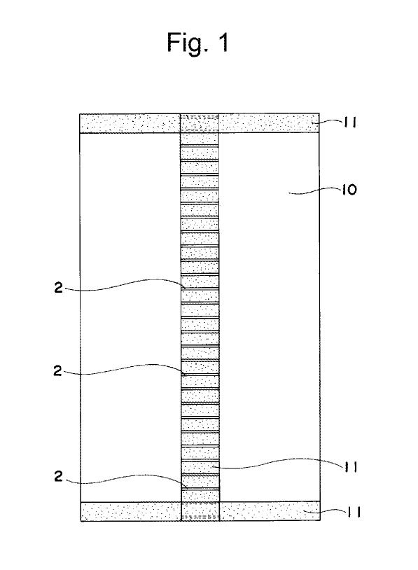

The freshness preservation method of the present invention uses a storage bag 10 formed by heat-sealing a nonporous film 1 (as shown in FIG. 1). Non-adhesive portions are continuously formed on the heat sealed portion 11 in a stripe pattern so that the non-adhesive portions function as vent holes 2 communicating with an outside of the storage bag 10.

The carbon dioxide generated by the vegetable, fruit or fresh flower in the storage bag 10 is discharged from the vent holes 2. Oxygen of the outside of the storage bag 10 is shut off by the vent holes 2. As described above, the vegetable, fruit or fresh flower is allowed to breathe only by oxygen entered in the storage bag 10 with the vegetable, fruit or fresh flower so that an oxygen concentration in the storage bag 10 is gradually reduced according to a degree of breathing of the vegetable, fruit or fresh flower. Thus, damage of the vegetable, fruit or fresh flower is minimized and activity of the vegetable, fruit or fresh flower is suppressed.

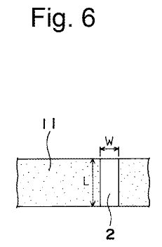

The vent holes 2 to discharge the carbon dioxide and shut off the oxygen can be operated in the following conditions. Namely, a width W of the vent holes 2 is specified to 0.2 mm to 5 mm, and a ratio L/W between the width W and a length L of the vent holes 2 is specified to 10 to 200. Here, the length L is a distance from an inside of the storage bag 10 to the outside of the storage bag 10 (as shown in FIG. 6).

The ratio L/W between the length L and the width W of the vent holes 2 is preferably within the range of 10 to 200 and is particularly preferably within the range of 15 to 150. If the width W is less than 0.2 mm, the carbon dioxide cannot be discharged enough and there is a risk of burst of the storage bag 10. On the contrary, if the width W is more than 5 mm, preservability of the contents may be deteriorated. If the ratio L/W between the length L and the width W is less than 10, preservability of the contents is deteriorated remarkably. If the ratio L/W is more than 200, moisture may be condensed on the inside of the vent holes and the carbon dioxide may not be discharged enough.

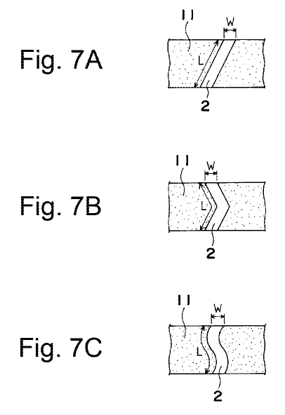

The vent holes 2 shown in the figure is formed perpendicularly to a longitudinal direction of the heat sealed portion 11 (as shown in FIG. 6). The shape of the vent holes 2 can be arbitrarily selected without limited to the above described shape. For example, the vent holes 2 can be formed in a shape of an oblique line as shown in FIG. 7A, a polygonal line as shown in FIG. 7B or a curved line as shown in FIG. 7C. The vent holes 2 having the shape of the polygonal line or the curved line are preferred since the ratio between the length L and the width W can be easily increased.

The number of the vent holes 2 formed on the heat sealed portion 11 is preferably 5 to 200, more preferably 20 to 100. If the number of the vent holes 2 is less than 5, the carbon dioxide is not discharged enough, and there is a possibility of breakage of the storage bag 10. On the contrary, if the number of the vent holes 2 is more than 200, preservability of the vegetable, fruit or fresh flower may be deteriorated.

The freshness preservation bag of the present invention is used for carrying out the freshness preservation method of the present invention. The storage bag 10 is formed by heat-sealing the nonporous film 1 to form the non-adhesive portions, which function as the vent holes 2, on the heat sealed portion 11. For the heat sealing, the non-adhesive portions can be formed in a stripe pattern by using a device having a heater formed in a concavo-convex shape or by discontinuously applying the adhesive.

As a specific example of the nonporous film 1 forming the storage bag 10, polyethylenes such as low density polyethylene, high density polyethylene and linear low density polyethylene which are frequently used for packaging, stretched or unstretched polypropylenes, polyesters such as polyethylene terephthalate, and nylons such as nylon 6 can be used, for example. In addition, the above described materials can be laminated with each other. In the above described materials, low density polyethylene and polypropylene are particularly preferred in the viewpoint of gas permeability, cost, strength and chemical stability.

The nonporous film 1 can have a structure formed by laminating an oxygen barrier layer. For the oxygen barrier layer, a layer made of a polymer including vinyl alcohol or vinylidene chloride as a component, a layer formed by vapor-depositing one of silica, alumina and aluminium, or a layer of metallic foil can be selected, for example.

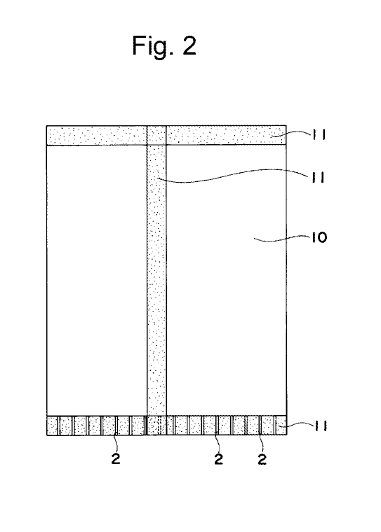

A thickness of the nonporous film 1 is not particularly limited. In the viewpoint of strength and cost, the thickness is preferably approximately 15 μm to 800 μm, and more preferably 20 μm to 400 μm. The position (location) of the vent holes 2 formed on the nonporous film 1 can be arbitrarily selected from any part of the heat sealed portion 11. For example, the vent holes 2 can be formed on the heat sealed portion 11 which is provided along the center of a backside of the storage bag 10 (as shown in FIG. 1). Alternatively, the vent holes 2 can be formed on the heat sealed portion 11 which is provided on the upper and lower openings of the storage bag 10 (as shown in FIG. 2).

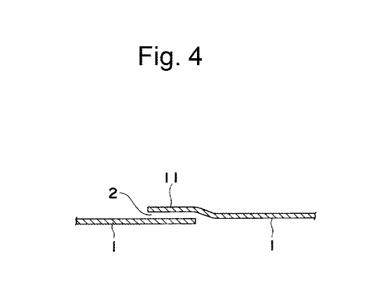

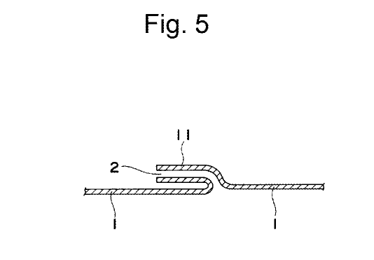

The vent holes 2 shown in the figure are formed on the heat sealed portion 11 which is formed by laminating the external surface and the internal surface of the nonporous film 1 (as shown in FIG. 4). Alternatively, the vent holes 2 can be formed on the heat sealed portion 11 which is formed by laminating the internal surfaces of the nonporous film 1 with each other (as shown in FIG. 5).

In the heat sealed portion 11 formed by laminating and heat-sealing both ends of the nonporous film 1, the vent holes 2 of the present invention are formed by sealing the heat sealed portion 11 so that the adhesive portions and the non-adhesive portions are alternately arranged showing a stripe pattern. The method of the heat-sealing is not particularly limited. Conventionally known method can be used. For example, the stripe pattern can be formed by using a device having a heater formed in a concavo-convex shape. Alternatively, the stripe pattern can be formed by discontinuously applying the adhesive.

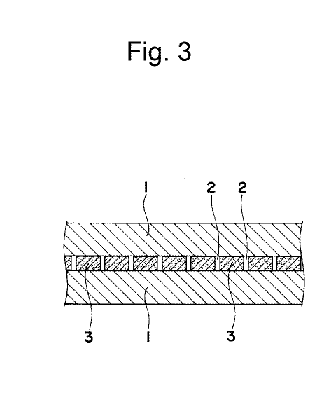

In the heat sealed portion 11 shown in the figure, the stripe pattern is formed by the adhesive portions and the non-adhesive portions (as shown in FIG. 3). On the adhesive portions, a pressure sensitive adhesive 3 is applied on the nonporous film 1. On the non-adhesive portions, the pressure sensitive adhesive 3 is not applied. After the pressure sensitive adhesive is dried, the nonporous films 1 are laminated with each other and wound up by a roll to pressurize and adhere them. Thus, the portion to which the pressure sensitive adhesive is not applied becomes the non-adhesive portions. Consequently, the non-adhesive portions form the vent holes 2 communicating with the outside of the storage bag 10.

TABLE 1

| | | | 0th | 1st | 2nd | 3rd | 4th | 5th | 6th | 7th |
|---|---|---|---|---|---|---|---|---|---|---|
| temp. | gas | item | day | day | day | day | day | day | day | day |
| 5° C. | CO₂ | roses | 0.0 | 2.7 | 3.7 | 4.1 | 6.6 | | | 6.9 |
| | | chives | 0.0 | 1.8 | 2.0 | 2.9 | 4.8 | | | 6.2 |
| | O₂ | roses | 21.0 | 18.1 | 16.8 | 16.7 | 14.4 | | | 13.8 |
| | | chives | 21.0 | 18.8 | 16.7 | 16.1 | 15.2 | | | 14.8 |
| 15° C. | CO₂ | roses | 0.0 | 3.0 | 3.2 | 9.1 | 10.0 | | | 15.0 |
| | | chives | 0.0 | 4.2 | 6.3 | 6.9 | 12.0 | | | 22.0 |
| | O₂ | roses | 21.0 | 18.0 | 17.2 | 16.1 | 15.9 | | | 8.8 |
| | | chives | 21.0 | 17.7 | 15.9 | 15.0 | 5.9 | | | 1.2 |

Table 1 shows a result of testing gas concentration according to the number of preservation days when the freshness preservation bag of the present invention was used. For the storage bag 10 used in the test, a low density polyethylene having a thickness of 0.2 mm was used for the nonporous film 1, a size was 18 mm×415 mm, a width of the heat sealed portion 11 was 11 mm, and a width of the vent holes 2 was 0.6 mm. 100 g of roses or 100 g of chives were entered in the storage bag 10 and the gas concentration was tested for seven days under the environment of 5° C. and the environment of 15° C.

From the result of Table 1, it is proved that the oxygen concentration was reduced and the carbon dioxide was increased according to the difference of the kind and the environmental temperature of the vegetable, fruit or fresh flower in the freshness preservation bag of the preset invention.

TABLE 2

| | | comparison result | |
|---|---|---|---|
| | number | conventional freshness | freshness preservation bag |
| item | of days | preservation bag | of the present invention |
| cut | 16 days | slightly changed into | color is not changed |
| vegetables | | brown color | keeping freshness |
| carrots | 19 days | sprouting | no change compared to |
| | | | before storage |
| chives | 19 days | decay at the tip | no change compared to |
| | | | before storage, eatable |
| roses | 7 days | flowers and leaves | state sold on store, |
| | | were withered | with commercial value |

In Table 2, the same vegetable, fruit or fresh flower was separately stored in the freshness preservation bag of the present invention and the conventional freshness preservation bag to observe the conditions after the passage of time. In this experiment, 100 g of cut vegetables, 100 g of carrots, 100 g of chives and 100 g of roses were stored in each of the bags to confirm the days before change in appearance was seen for the first time. For the storage bag of the present invention, a low density polyethylene having a thickness of 0.2 mm was used, a size was 18 mm×21 mm, a width of the heat sealed portion 11 was 11 mm, and a width of the vent holes 2 was 0.6 mm. For storing the chives, the bag having a size of 18 mm×415 mm was used. For the “conventional” freshness preservation bag, a polypropylene bag when purchasing the vegetable, fruit or fresh flower was used.

According to the experiment, change was seen after approximately 16 to 19 days for the vegetable, fruit or fresh flower stored in the conventional freshness preservation bag. On the other hand, no change was seen for the vegetable, fruit or fresh flower stored in the freshness preservation bag of the present invention. It is notable that flowers and leaves of the roses, which are fresh flowers, were withered miserably in the conventional bag. On the contrary, the roses keep fresh state in the storage bag of the present invention enough to be sold on the store again.

The present invention is industrially applicable because it can be valuably used for hunting or sport shooting.

Note that, this invention is not limited to the above-mentioned embodiments. Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

What is claimed is:

1. A freshness preservation method, comprising the step of;
entering a vegetable, fruit or fresh flower in a storage bag that is formed by heat-sealing a nonporous film to continuously form non-adhesive portions on a heat sealed portion in a stripe pattern so that the non-adhesive portions function as vent holes communicating with an outside of the storage bag, wherein
carbon dioxide generated by the vegetable, fruit or fresh flower in the storage bag is discharged from the vent holes, and
oxygen of the outside of the storage bag is shut off by the vent holes to allow the vegetable, fruit or fresh flower breathe only by the oxygen entered in the storage bag with the vegetable, fruit or fresh flower so that an oxygen concentration in the storage bag is gradually reduced according to a degree of breathing of the vegetable, fruit or fresh flower.

2. The freshness preservation method according to claim 1, wherein
a width W of the vent holes is 0.2 mm to 5 mm, and
a ratio L/W between the width W and a length L of the vent holes is 10 to 200, the length L being a distance from an inside of the storage bag to the outside of the storage bag.

3. The freshness preservation method according to claim 1, wherein
the vent holes are formed on the heat sealed portion of the storage bag which is formed by heat-sealing the nonporous film, and
the oxygen concentration in the storage bag is gradually reduced according to a degree of the breathing of the vegetable, fruit or fresh flower.

4. The freshness preservation method according to claim 3, wherein
the nonporous film has a single layer structure made of one of polyethylene, polypropylene, polyester and nylon, or a laminated structure of a combination of at least two of the polyethylene, the polypropylene, the polyester and the nylon.

5. The freshness preservation method according to claim 3, wherein
the nonporous film has a structure formed by laminating an oxygen barrier layer, and
the oxygen barrier layer is formed by a layer made of a polymer including vinyl alcohol or vinylidene chloride, a layer formed by vapor-depositing one of silica, alumina and aluminium, or a layer of metallic foil.

6. The freshness preservation method according to claim 3, wherein
5 to 200 vent holes are formed on the heat sealed portion.
